(19) United States
(12) Patent Application Publication
(10) Pub. No.: US 2003/0188997 A1
(43) Pub. Date: Oct. 9, 2003

(54) Semiconductor inspection system and method

(76) Inventors: Beng Soon Tan, Penang (MY); Yew Fei Tham, Singapore (SG)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/371,320

(22) Filed: Feb. 20, 2003

Related U.S. Application Data
(60) Provisional application No. 60/368,879, filed on Mar. 29, 2002.

(51) Int. Cl. B07C 5/02

(52) U.S. Cl. 209/538; 209/564

(57) ABSTRACT

A semiconductor inspection system transports devices in trays from an input stacker to a flipping mechanism along a first inspection path in a first direction and from the flipping mechanism to an output stacker along a second inspection path in a second direction that is a different direction than the first direction. The flipping mechanism moves the devices from the first inspection path to a flipping location, flips the devices at the flipping location, and moves the devices to the second inspection path. In this manner, the devices can be inspected by a plurality of stations on different inspection paths and in different directions. One of the stations is an integrated station that performs both mark inspection and sorting of defective devices. A semiconductor inspection method is also described.

### RELATED APPLICATION

This application claims priority to U.S. Provisional Application No. 60/368,879, entitled SEMICONDUCTOR INSPECTION SYSTEM AND METHOD,” filed on Mar. 29, 2002, which is hereby incorporated herein by reference.

### FIELD

The present invention relates generally to inspection systems and, more particularly, to a semiconductor inspection system and method.

### BACKGROUND

A semiconductor inspection system inspects integrated circuit (IC) devices and printed circuit board (PCB) devices. The devices are generally placed in trays and loaded at an input stacker, forwarded to different inspection stations, and then forwarded to an output stacker, where the inspected devices are unloaded. Typically, the devices are inspected on both sides (i.e., the top side and bottom side of the devices) for marking and structural defects, which involves inverting or flipping the devices using one or more trays. The devices, however, can be damaged by frequent handling, especially during the flipping process. To reduce damage to the devices, handling of the devices should be minimized.

Prior inspection apparatuses use a transport mechanism that provides a straight-lined path between an infeed station and outfeed station. The prior inspection handler apparatus arranges serially inspection stations along the straight-lined path in between the infeed station and outfeed station. One disadvantage of such an apparatus is that the infeed station and outfeed station are located at opposite ends of the straight-lined path, making it inconvenient for users to load and unload devices in trays. Furthermore, because the infeed station and outfeed station are at opposite ends of the straight-linear path, the apparatus occupies a large area in the environment in which this inspection handler is used.

Another disadvantage of the prior inspection handler apparatus is that, after inversion, devices are transported from a final inspection station to a separate sorting station to sort defective devices. This is inefficient because devices are transported to two separate stations for final inspection and sorting of defective devices after inversion. The prior inspection handler apparatus also uses an inverter station having an up/down movable frame supporting a rotatable tray holder that moves the rotatable tray holder each time it makes an up or down movement, which in turn, places a high level of stress on the movable frame.

There exists, therefore, a need for an improved inspection system and method, which overcome the disadvantages of the prior inspection apparatus.

### SUMMARY

According to one aspect of the invention, semiconductor inspection system comprises an input stacker, an output stacker, a flipping mechanism, a first transport, a second transport, and a plurality of inspection stations. The flipping mechanism moves devices in a tray from a first inspection path to a flipping location. At the flipping location, the flipping mechanism flips the devices and then moves the devices from the flipping location to a second inspection path. The first transport transports the devices from the input stacker to the flipping mechanism along the first inspection path in a first direction. The second transport transports the devices from the flipping mechanism to the output stacker along the second inspection path in a second direction. The second direction is different than the first direction. The plurality of inspection stations inspect the devices being transported along the first inspection path and the second inspection path.

According to another aspect of the invention, an inspection method for inspecting devices transports the devices in a first tray from an input stacker to at least one inspection station along a first inspection path. The devices are inspected in the first tray at each inspection station, and transported to a flipping mechanism along the first inspection path. At the flipping mechanism, the devices in the first tray are flipped into a second tray and transported to a second inspection path, and to an integrated inspection and sorting station from the flipping mechanism along the second inspection path. The integrated inspection and sorting station performs mark inspection of the devices in the second tray and sorts defective devices in the second tray.

According to another aspect of the invention, a flipping mechanism includes a loading bay, unloading bay, support frame, flipping unit, and a tray transfer unit. The flipping unit is mounted on the support frame, and flips at least one of a first tray and a second tray at a flipping location laterally from the loading bay. The tray transfer unit is mounted on the support frame, and moves at least one of the first tray and the second tray from the loading bay to at least one of the flipping location and unloading bay.

Other features and advantages will be apparent from the accompanying drawings, and from the detailed description, which follows below.

### BRIEF DESCRIPTION OF THE DRAWINGS

The accompanying drawings, which are incorporated in and constitute a part of this specification, illustrate exemplary implementations and embodiments. In the drawings,

FIGS. 1A and 1B illustrate a front and side view of embodiments of a semiconductor inspection system;

FIG. 1C illustrates a plan view of the semiconductor inspection system;

FIG. 2 illustrates a pictorial layout of modules in the semiconductor inspection system;

FIG. 3 illustrates a block diagram of modules in the semiconductor inspection system;

FIG. 4 illustrates a schematic plan view of the semiconductor inspection system illustrating an inspection flow having a first inspection path and a second inspection path;

FIG. 5 illustrates a modular breakdown tree diagram of subassemblies for modules in the semiconductor inspection system;

FIG. 6 illustrates a flow diagram of a method for implementing a flipping operation by the semiconductor inspection system;

FIGS. 7A-7L illustrates movement sequences of a device tray and a cover tray by the flipping mechanism of the semiconductor inspection system;

FIG. 8 illustrates an enlarged perspective view of the flipping mechanism of the semiconductor inspection system;

FIG. 9 illustrates one section view of the support frame and flipper for the flipping mechanism of the semiconductor inspection system;

FIG. 10 illustrates another section view of the support frame and flipper for the flipping mechanism of FIG. 9;

FIG. 11 illustrates one section view of the clamping devices of the flipping mechanism of the semiconductor inspection system;

FIG. 12 illustrates another section view of the clamping devices of the flipping mechanism of FIG. 11 of the semiconductor inspection system;

FIG. 13 illustrates one section view of the drive unit for the clamping devices of FIGS. 11-12;

FIG. 14 illustrates one section view of the tray transfer unit of the flipping mechanism of the semiconductor inspection system;

FIG. 15 illustrates another section view of the tray transfer unit of the flipping mechanism of FIG. 14;

FIG. 16 illustrates one section view of the tray handler of the tray transfer unit of FIG. 15;

FIG. 17 illustrates another section view of the tray handler of the tray transfer unit of FIGS. 15 and 16; and

FIG. 18 illustrates another section view of the tray handler of the tray transfer unit of FIGS. 15-17.

### DETAILED DESCRIPTION

Reference will now be made in detail to exemplary implementations and embodiments, examples of which are illustrated in the accompanying drawings. Wherever possible, the same reference numbers will be used throughout the drawings to refer to the same or like parts.

A. Semiconductor Inspection System Overview

In accordance with embodiments of the present invention, a semiconductor inspection system is disclosed that provides a modular, automated tray handler inspection system for inspecting semiconductor devices or packages (“devices”) in trays. The compact, modular design of the semiconductor inspection system allows for easy delivery and setup.

The semiconductor inspection system can transport devices in a tray from input stacker to a flipping mechanism along a first inspection path and from the flipping mechanism to an output stacker along a second inspection path. The devices can be transported in multiple, different directions using the first and second inspection paths. In this manner, the devices can traverse a non-linear path from the input stacker to the output stacker for inspection by a plurality of inspection stations. Transporting devices in this way allows the input stacker and output stacker to be located in close proximity to each other, e.g., being located with a lateral offset. The close proximity of the input stacker to the output stacker makes loading and unloading of devices more convenient to users.

In embodiments of the present invention, the flipping mechanism can move devices in a tray from the first inspection path to a flipping location, flip the devices at the flipping location, and, after flipping move the devices to the second inspection path. In this manner, the flipping mechanism allows the devices to be transported in one direction on the first inspection path and in a different direction on the second inspection path Furthermore, the flipping mechanism may enable devices or units in a tray (“device tray”) to be inverted or flipped using a “cover tray.” The flipping mechanism uses a self-aligning process to place properly the cover tray onto the device tray. This self-alignment process provides accurate covering of trays to reduce damage to the devices in the trays. The flipping mechanism can also comprise sensors to check if a cover tray is properly engaged with a device tray. By using such sensors, the flipping mechanism can provide safeguards if devices are dislodged in the trays.

If properly covered, the flipping mechanism transports the device tray and cover tray to a rotation/flipping unit (“flipper”) that flips the trays. In one embodiment, the flipper can use single-actuator cam-operated fingers for gripping the trays at both ends. The fingers, at both ends, can be synchronized for efficient flipping of the trays. As a result, a minimal amount of torque is necessary to flip the trays. In one embodiment, the flipper includes a pair of fingers that are synchronized by a tandem shaft. The fingers can grip trays of varying thickness. The flipping mechanism optionally includes a bypass feature such that flipping devices in the trays is avoided, whereby a device tray can move directly from the first inspection path to the second inspection path. The flipping mechanism can include one or more vibration mechanisms to vibrate devices in the trays (e.g., the device tray or the cover tray) before or after flipping to dislodge devices that are caught in cavities of either the cover tray or device tray.

Additionally, according to embodiments of the present invention, the semiconductor inspection system uses a single, integrated station that performs both final vision inspection and sorting after a flipping operation. For example, a single station can be positioned after the flipping mechanism to perform both mark inspection and sorting of defective devices, avoiding reliance on separate and distinct stations to inspect and sort defective devices after the flipping operation.

In the following description, reference to “devices” or “units' can refer to any type of semiconductor devices or packages including CSP, μBGA, BGA, TSOP, QFP or other like devices. The devices can vary in size, e.g., the devices can have 5×5 mm to 13×13 mm or 14×14 mm to 20×20 mm dimension sizes, for inspection by the inspection system disclosed herein. Such devices can be transported in trays, examples of which include JEDEC type trays. The trays can arrange the devices in a two-dimensional array for inspection. The semiconductor inspection system can inspect the devices placed in such trays in a live-bug orientation (contacts pointing downward) or in a dead-bug orientation (contacts pointing upwards).

B. Layout, Modules, and Subassemblies

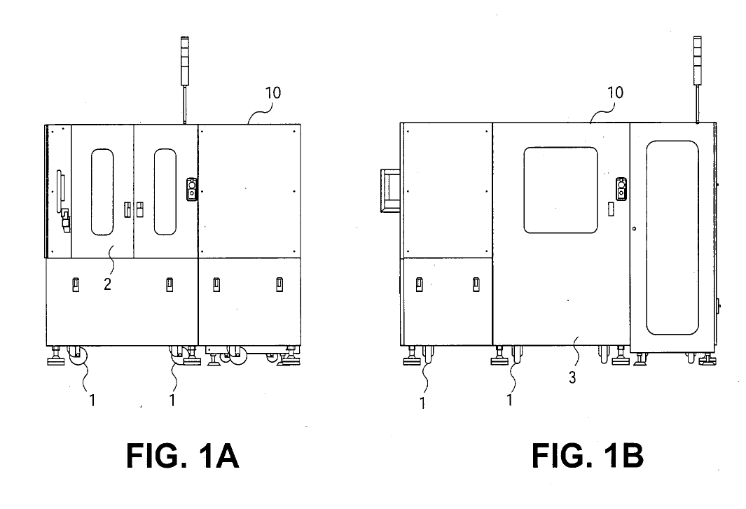

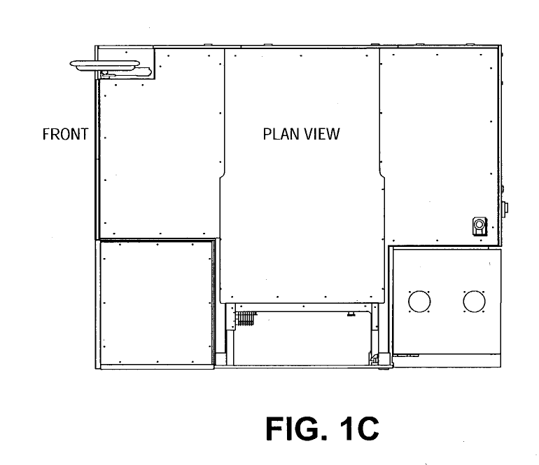

FIGS. 1A and 1B illustrate a front and side view of a semiconductor inspection system 10. FIG. 1C illustrates a plan view of one embodiment of semiconductor inspection system 10. As shown, semiconductor inspection system 10 has a compact, modular layout for efficient use of floor space. The system 10 includes a front door 2 and a side door 3 for easy access into the interior portion of the semiconductor inspection system. Semiconductor inspection system 10 is capable of being moved in all directions using rollers 1.

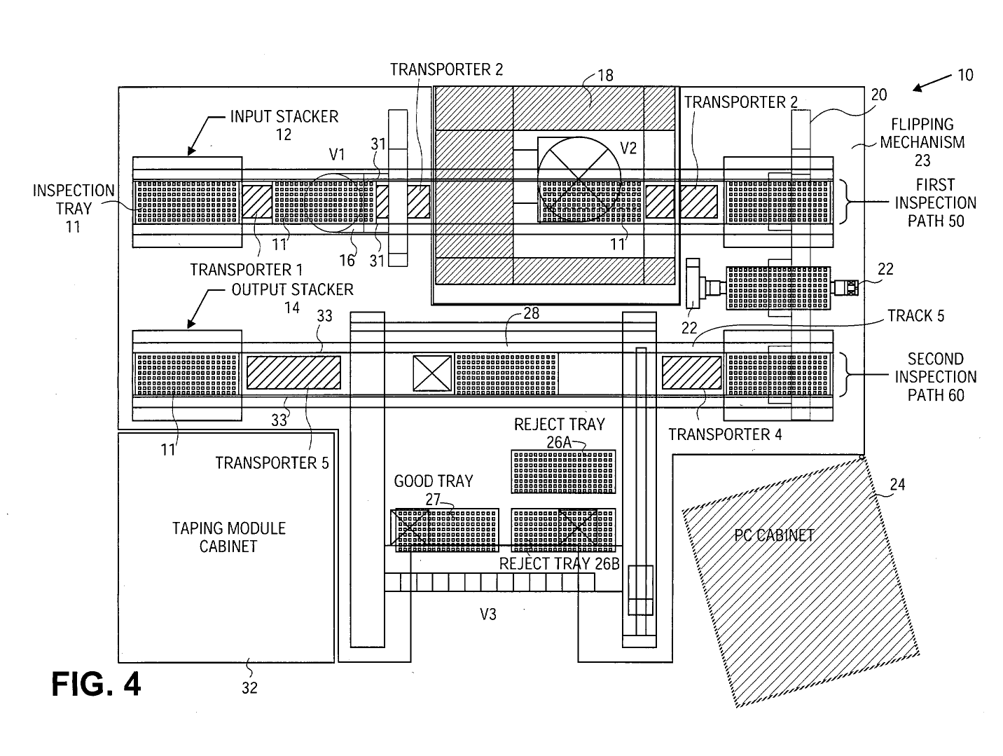

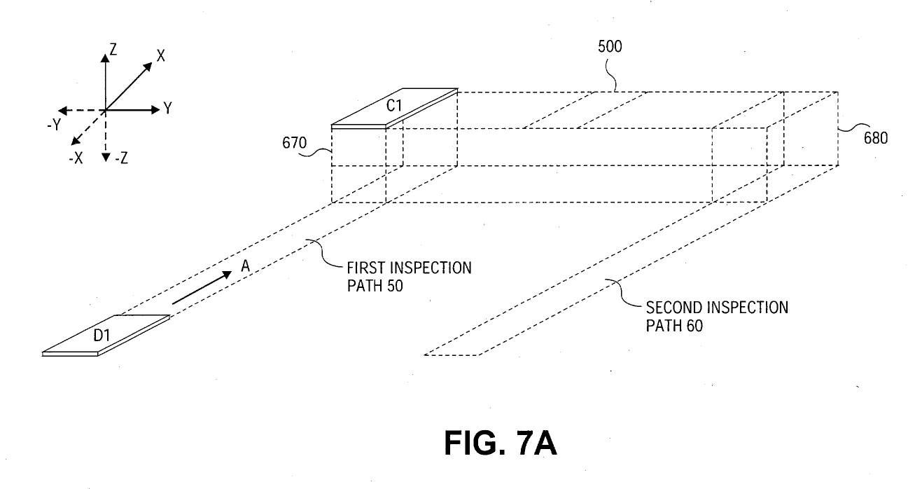

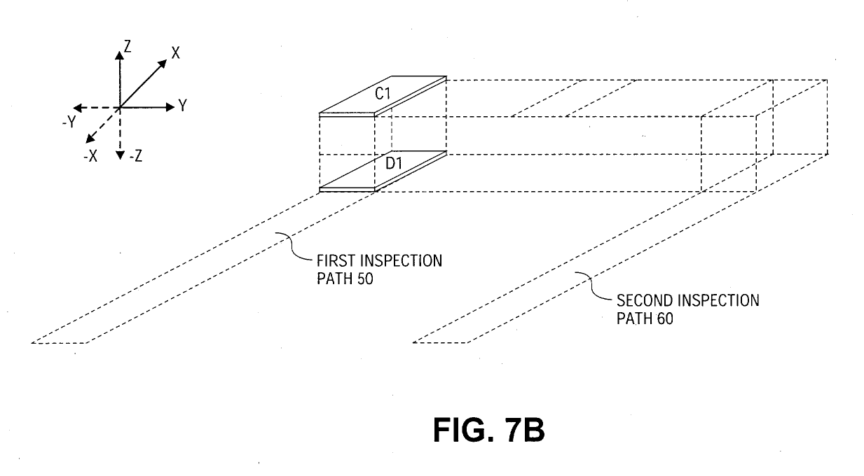

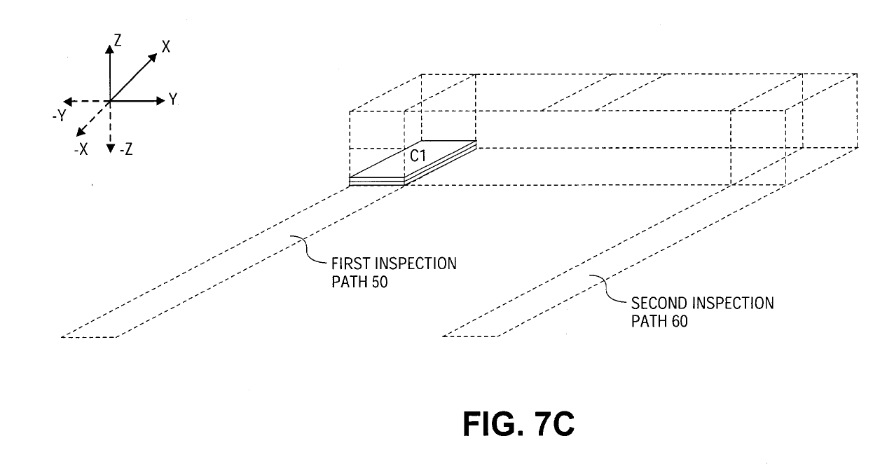

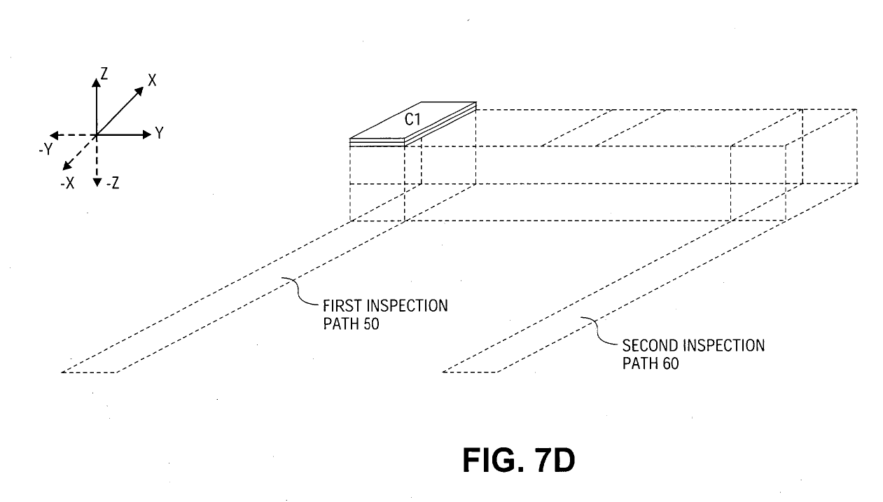

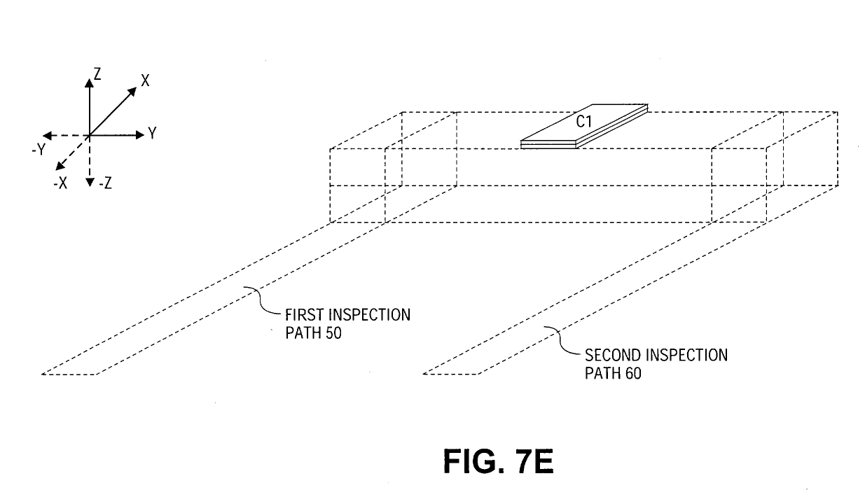

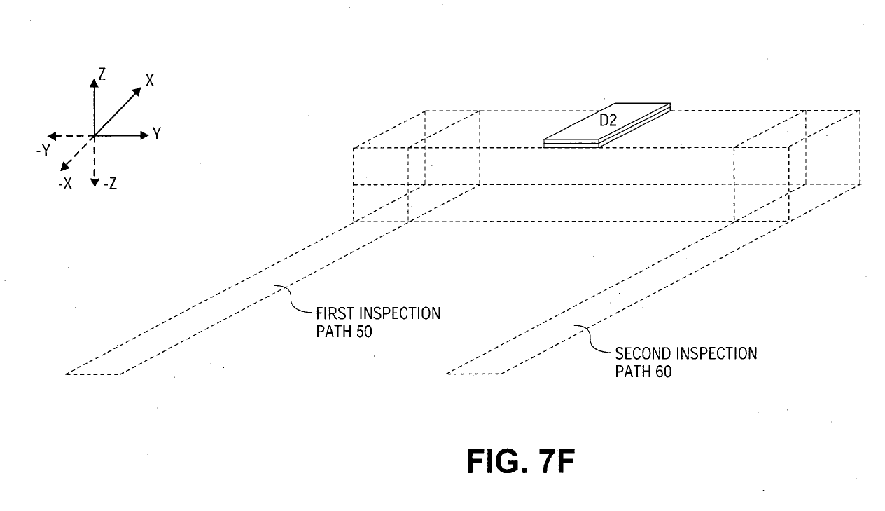

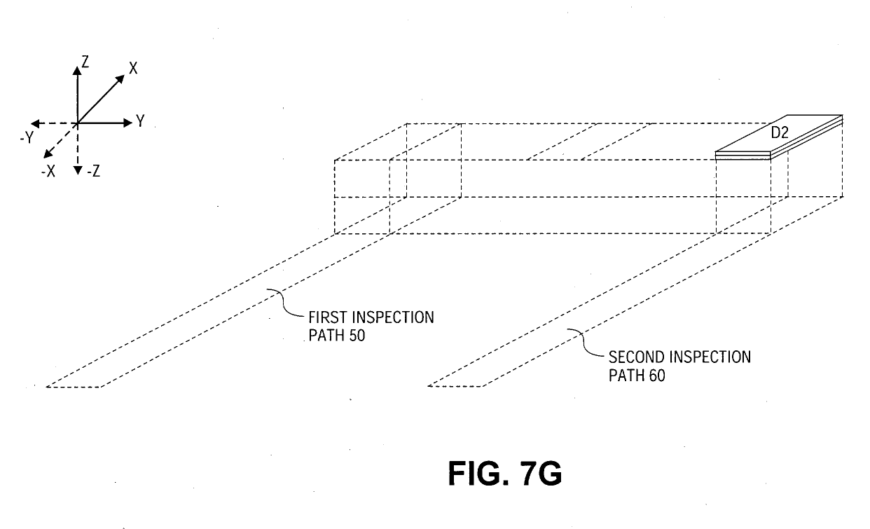

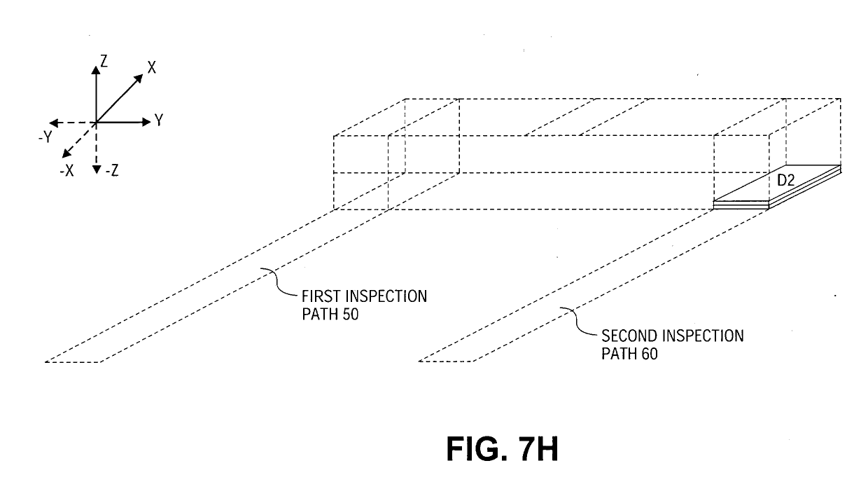

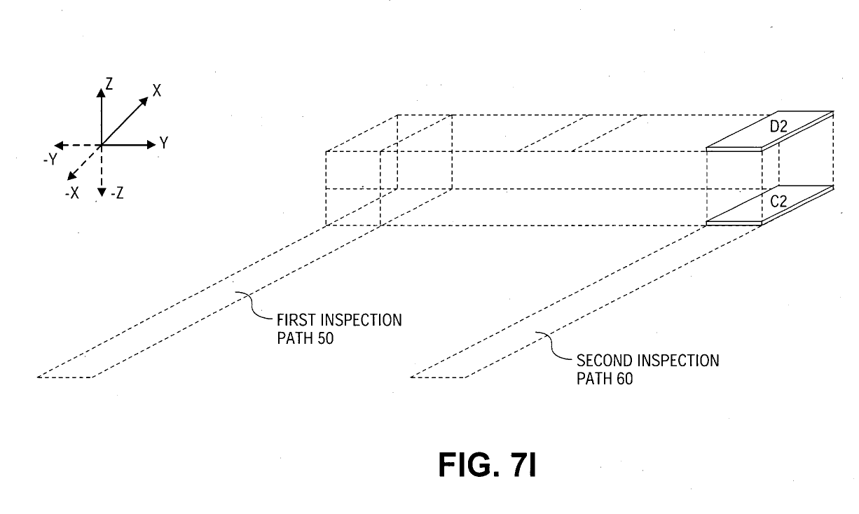

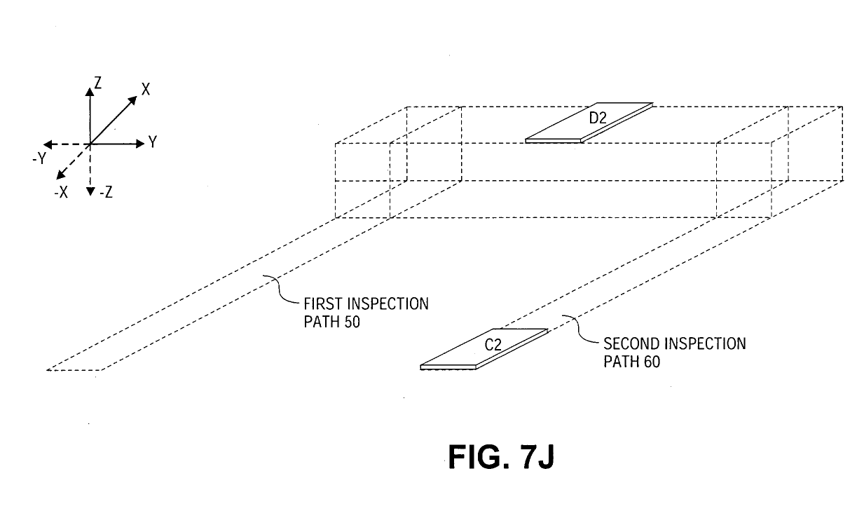

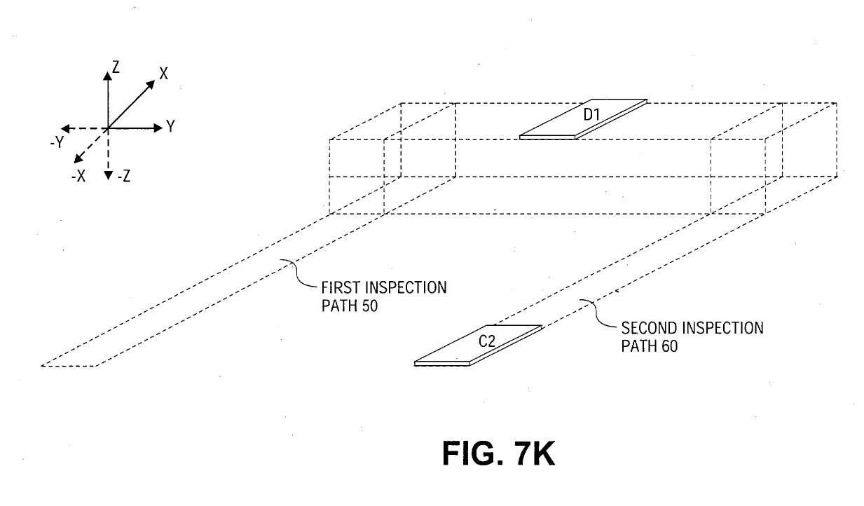

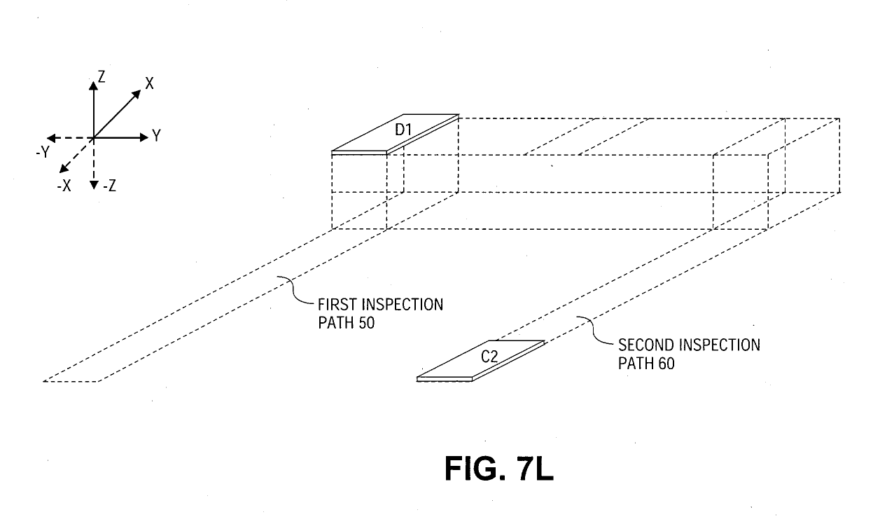

As will be described in further detail below, semiconductor inspection system 10 includes transporters and tracks to define a first inspection path 50 (shown in FIG. 4) and a second inspection path 60 (shown in FIG. 4). These transporters and tracks transport devices contained in trays along the first and second inspection paths. Semiconductor inspection system 10 also includes stations (i.e., stations 16, 18, and 29) arranged along the first and second inspection paths 50 and 60 for vision inspection and sorting of defective devices. In one embodiment, a single, integrated station 29 (shown in FIG. 4) can be used to perform both mark inspection and sorting of defective devices. Semiconductor inspection system 10 further includes a flipping mechanism 23 (shown in FIGS. 7A-15) to flip devices from one tray to another tray during inspection and to move the devices from the first inspection path 50 to the second inspection path 60. Other modules, as described below, can be used within semiconductor inspection system 10.

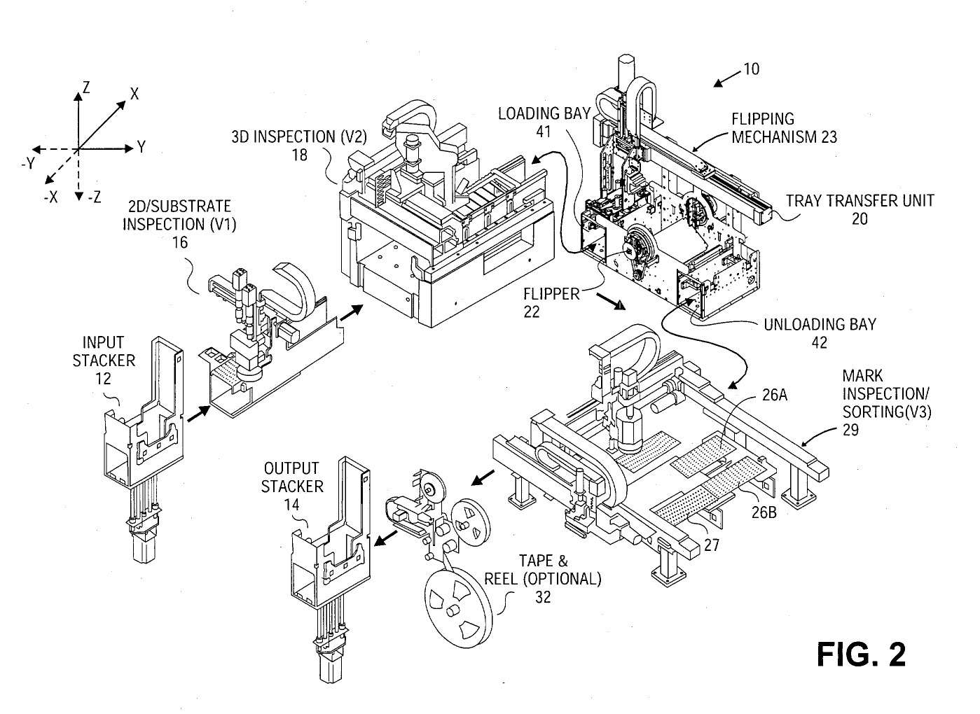

FIGS. 2 through 4 illustrate embodiments of the basic modules of semiconductor inspection system 10, their layout, and the transporting of devices in trays along the first and second and inspection paths. Referring to FIG. 2, a pictorial layout of the basic modules is shown to illustrate their relative spatial positioning within semiconductor inspection system 10. As shown, semiconductor inspection system 10 includes an input stacker 12, a 2D/substrate inspection station (V1) (“V1 inspection system 16”), a 3D inspection station (V2) (“V2 inspection station 18”), a flipping mechanism 23, a mark inspection/sorting (V3) (“V3 inspection station 29”). The tape and reel module 32 is an optional module for semiconductor inspection system 10.

Input stacker 12, V2 inspection station 16, and V3 inspection station 18 are arranged serially along the first inspection path 50 (shown in FIG. 4) in which V3 inspection station 18 abuts a loading bay 41 of flipper mechanism 23. V3 inspection station 29, optional tape and reel module 32, and output stacker 14 are arranged serially along the second inspection path 60 (shown in FIG. 4) in which V3 inspection 29 abuts an unloading bay 42 of flipping mechanism 23. Devices at loading bay 41 of flipping mechanism 23 can move vertically and laterally to unloading bay 42 of flipping mechanism 23. In this manner, devices on first inspection path 50 can be transported for inspection on second inspection path 60.

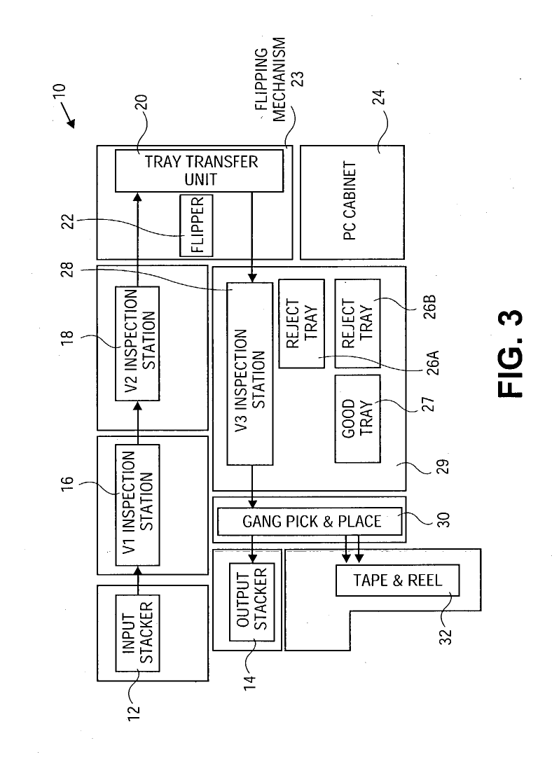

Referring to FIG. 3, semiconductor inspection system 10 also includes a PC cabinet 24 and a gang pick and place module 30 that is optional. For purposes of illustration, the optional gang pick and place module 30 is not shown in FIG. 4, which illustrates semiconductor inspection system 10 transporting devices in an inspection tray 11 (“tray 11”) to and through V1, V2, and V3 inspection stations 16, 18, and 29 along first inspection path 50 and second inspection path 60. As shown in FIG. 4, multiple trays 11 can be transported through semiconductor inspection system 10 at a time for inspection. Semiconductor inspection system 10 can also have a taping module cabinet 32 to house tape and reel module 32 and/or gang pick and place module 30, as shown in FIG. 3.

As will be described in further detail below, semiconductor inspection system 10 can move devices in trays from input stacker 12 to flipping mechanism 23 along first inspection path 50 and from flipping mechanism 23 to output stacker 14 along second inspection path 60 in multiple x-axis directions. Additionally, at flipping mechanism 23, devices in trays can move in multiple z-axis and y-axis directions to traverse multiple x-y planes during flipping, and to move the devices between first inspection path 50 and second inspection path 60. In this manner, semiconductor inspection system 10 can move devices in a tray from input stacker 12 to output stacker 14 in a non-linear manner.

1. Overall Operation

Referring to FIGS. 2 through 4, the operation of semiconductor inspection system 10 will now be described with regards to tray 11. Tray 11 containing devices for inspection stacked at input stacker 12 are transported to and through V1 and V2 inspection stations 16 and 18, respectively, to a loading bay 41 of flipping mechanism 23 along first inspection path 50. Transporters 1 and 2 can transport tray 11 on a track 31 along first inspection path 50 in a positive (+) x-axis direction. Tray 11 at loading bay 41 can be referred to as a “device tray.” V1 inspection station 16 performs two-dimensional parameter vision inspection and V2 inspection station 18 performs three-dimensional parameter inspection on devices in tray 11.

At loading bay 41 of flipping mechanism 23, a tray transfer unit 20 places a “cover tray” on the device tray, lifts both trays vertically in the positive (+) z-axis direction, and then transports the trays laterally in the positive (+) y-axis direction to a flipper 22. Flipper 22, using fingers, grabs ends of both trays and rotates the trays such that devices in the device tray (initially the bottom tray) are transferred to the cover tray (initially the top tray) to flip the devices. After flipping, tray transfer unit 20 moves the trays laterally in the positive (+) y-axis direction above unloading bay 42 of flipping mechanism 23 and lowers the trays vertically in the negative (−) z-axis direction into unloading bay 42. The bottom tray at unloading bay 42 is the original cover tray. Tray transfer unit 20 can transport the top tray (original device tray) back to loading bay 41 of flipping mechanism 20 to be used as a cover tray for another flipping operation.

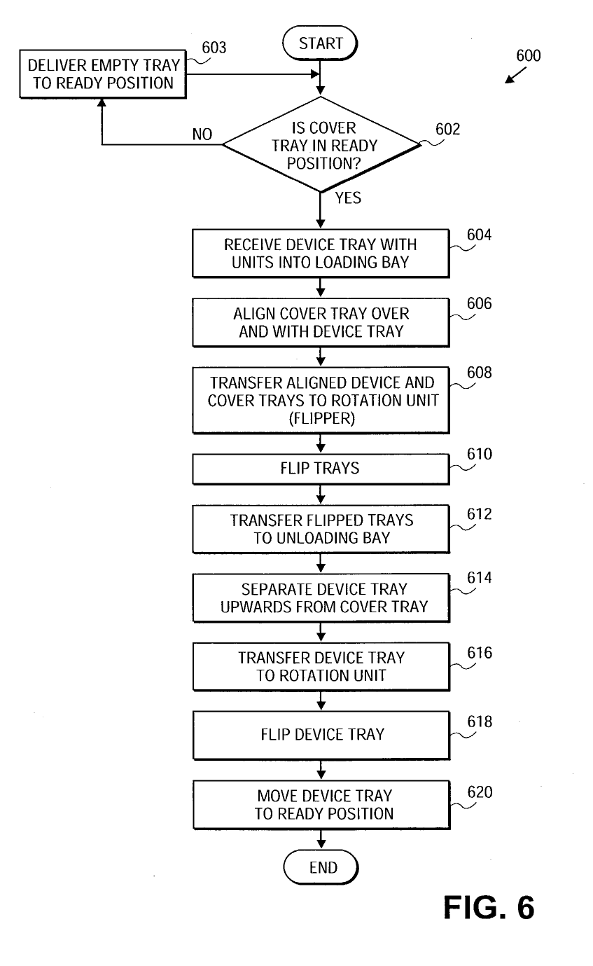

Alternatively, the original device tray at loading bay 41 of flipping mechanism 23 can by pass the flipping operation and be transported directly to unloading bay 42 of flipping mechanism 23 by tray transfer unit 20. In other examples, devices in the trays at either loading bay 41 or unloading bay 42 can be vibrated using one or more vibrating mechanisms, as described in further detail below, to dislodge devices caught in cavities of the trays. The details of flipping mechanism 23 and the flipping operation are further described in detail regarding FIGS. 6-18.

Tray 11 with the flipped or inverted devices can then be transported to and through V3 inspection station 29 along second inspection path 60 that performs both mark vision inspection and sorting of defective devices. For example, V3 inspection station 29 can perform a final mark inspection and then sort defective devices into reject trays 26A and 26B and good devices into a good tray 27. Good tray 27 or tray 11 can then be transported to and stacked at output stacker 14 along second inspection path 60. Transporters 4 and 5 can transport tray 11 on a track 33, which can include track 5 described below, along second inspection path 60 in a negative (−) x-axis direction. Tray 11 can also be transported to and through optional stations such as gang pick and place module 30 or tape and reel module 32 along second inspection path 60. Station 30 can provide an additional pick and place operation on devices in trays on second inspection path 60, and station 32 can add a tape material to the devices for easy removal from tray 11.

2. Modular Breakdown and Subassemblies Details

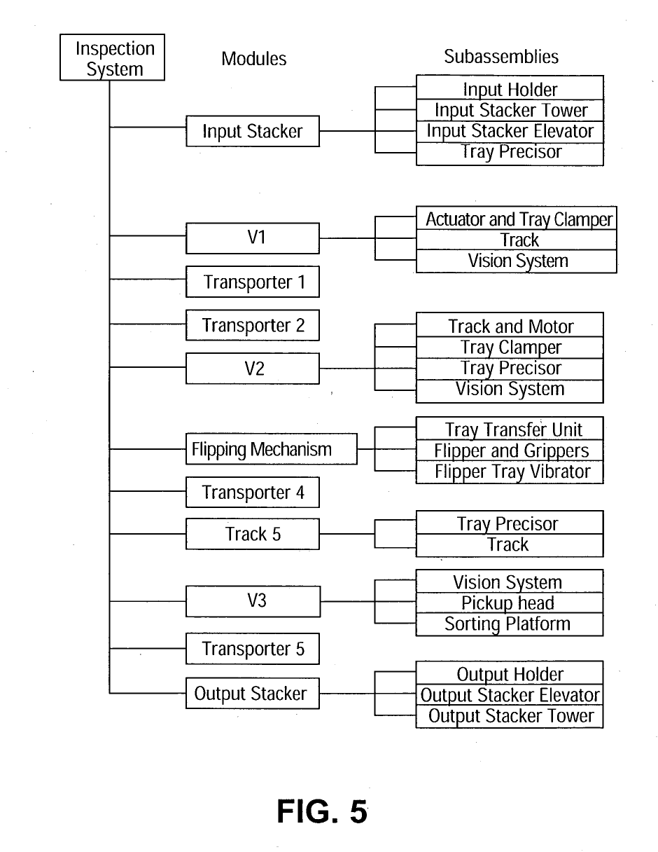

FIG. 5 illustrates one embodiment of a modular breakdown tree of modules and subassemblies for semiconductor inspection system 10. Referring to FIG. 5, the modular breakdown for semiconductor inspection system 10 can include: input stacker 12, V1 inspection station 16, transporters 1 and 2, V2 inspection station 18, flipping mechanism 23, transporters 4 and 5, track 5, V3 inspection station 29, output stacker 14, and cabinet 24. Optional modules such as gang pick and place module 30 and tape and reel module 32 can also be included.

a. Input and Output Stacker

In the following embodiments, as shown in FIGS. 2-4, input stacker 12 and output stacker 14 can be located in close proximity to each other with a lateral offset, which makes loading and unloading of trays convenient for users. In one embodiment, first inspection path 50 and second inspection path 60 run parallel to each other. Semiconductor inspection system 10 can have other convenient locations for input stacker 12 and output stacker 14. For example, input stacker 12 and output stacker 14 can be proximately located to each other in which first inspection path 50 and second inspection path 60 run perpendicular to each other. Other locations for input stacker 12 and output stacker 14 are possible using different orientations for first inspection path 50 and second inspection path 60.

Input stacker 12 stacks trays containing devices for inspection. Input stacker 12 can have a plurality of subassemblies including an input holder, input stacker tower, input stacker elevator, and tray precisor (FIG. 5). The input holder and input stacker tower hold the stacked trays in place for input stacker 12. The input stacker elevator lifts and lowers trays onto first inspection path 50. This elevator can be actuated by a motor (e.g., a brake-coupled motor). The tray precisor pushes and positions trays on first inspection path 50. Input stacker 12 can include other components such as, for example, sensors to provide information regarding the placement of trays in input stacker 12.

Output stacker 14 stacks trays of inspected devices. These trays may contain only good devices that pass inspection. Output stacker 14 can have subassemblies including an output holder, output stacker elevator, and output stacker tower (FIG. 5). The output holder holds stacks of trays similar to input stacker 12. The output stacker elevator lowers and lifts trays in output stacker 14. The output stacker elevator can be actuated by a motor (e.g., a motor-through lead screw type motor), which can also be brake-coupled. Output stacker 14 can include other components such as, for example, sensors to provide information regarding the placement of trays in output stacker 14. Output stacker 14 can also be constructed without sensors.

b. V1 Inspection Station

V1 inspection station 16 provides two-dimensional parameter vision inspection of devices in trays from input stacker 12. For example, V1 inspection station 16 can inspect two-dimensional parameters including body width and height, ball presence, ball diameter, ball offset, matrix offset, ball pitch, board width, ball quality, and contrast. V1 inspection station 16 can include subassemblies including an actuator and tray clamper, track, and vision system (FIG. 5). The actuator moves the tray clapper to hold a tray in place to prevent distortion (e.g., warping of the tray) during inspection. The actuator can be an x-axis actuator and pneumatically actuated to move the tray damper along the x-axis directions at V1 inspection station 16. V1 inspection station 16 can include other components such as, for example, rollers to facilitate movement of tray 11 on tracks 31 and sensors to provide information regarding the placement of trays in V1 inspection station 16. The vision system can be a computing system coupled to optical components to perform the two-dimensional parameter vision inspection.

C. Transporters 1 and 2

Transporters 1 and 2 transport trays from input stacker 12 to flipping mechanism 23 along first inspection path 50. Transporters 1 and 2 (including track 31) define first inspection path 50. Transporter 1 transports tray 11 from input stacker 12 to V1 inspection station 16. Transporter 1 can include transport subassemblies, examples of which include a motor (e.g., a motor-through a lead screw type motor). Transporter 1 can index tray 11 a row at a time through V1 inspection station 16 so that all devices in tray 11 can be inspected. Other components for transporter 1 can include a vertical actuating cylinder and a 90-degree clamp cylinder to clamp tray 11 for smooth transfer from one location to another location within V1 inspection station 16.

Transporter 2 transports tray 11 from V1 inspection station 16 to and through V2 inspection station 18 and flipper mechanism 23. Referring to FIG. 4, transporter 2 can transport simultaneously multiple trays, commonly referred to as a “walking beam.” Transporter 2 can include transport subassemblies, examples of which include a motor(e.g., a belt driven motor). Transporter 2 can also include cylinders that assist in the tray transporting process and act as pushers for tray 11, and a spring to prevent over pushing of the cylinders. The subassemblies of transporter 2 can be isolated from subassemblies of other stations and modules to minimize vibration within inspection system 10 during the transportation of devices in trays.

d. V2 Inspection Station

V2 inspection station 18 provides three-dimensional parameter visual inspection of the devices in tray 11 from V1 inspection station 16. For example, V2 inspection station 18 can inspect three-dimensional parameters including coplanarity, ball presence, ball height, body and height, ball quality, warpage, and contrast. V2 inspection station 18 can include subassemblies including a track and motor, tray clamper, tray precisor, and vision system (FIG. 5). Examples of the motor include a linear-motor to move tray 11 in an x-axis and y-axis directions. Track 31 can include the track for V2 inspection station 18. The tray damper and tray precisor (e.g., a cylinder) can hold tray 11 in a fixed position to prevent distortion to it during inspection at V2 inspection station 18. Other cylinders can be used to push tray 11 tray against a track wall or to guard against movement of tray 11 during inspection. A stopper cylinder can be used to stop tray 11 from moving in V2 inspection station 18. The vision system can be a computing system coupled to optical components to perform the three-dimensional parameter vision inspection.

e. Flipping Mechanism

Flipping mechanism 23 flips devices or units during inspection using a device tray and cover tray. Flipping mechanism 23 includes tray transfer unit 20 to provide lateral y-axis and vertical z-axis movements of trays during the flipping process. Tray transfer unit 20 can include a motor-pulley-timing belt with a linear actuator to provide y-axis movement and a motor driven ball screw to provide z-axis movement of trays. Flipper 22 includes fingers or grippers to grab ends of trays being transported by tray transfer unit 20 and flips or rotates the trays to transfer devices in one tray (“device tray”) into another tray (“cover tray”). The details of flipper mechanism 23 and the flipping operation are described in further detail below regarding FIGS. 6-18.

f. Transporters 4 and 5 and Track 5

Transporters 4 and 5 and track 5 transport tray 11 from flipping mechanism 23 to and through V3 inspection station 29 to output stacker 14 along second inspection path 60. Transporters 4 and 5 and track 5 define second inspection path 60. Transporter 4 transports tray 11 from flipping mechanism 23 to V3 inspection system 29. Transporter 4 can include a belt driven subassembly to transport tray 11. Other components of transporter 4 can include a cylinder to assist in the tray transporting process. The cylinder can act as a pusher and be spring loaded to prevent “over-pushing” of tray 11. Track 5 guides tray 11 during the transporting process by transporter 4. This track can include a number of sensors to detect the presence of tray 11 to ensure that no trays are present on track 5, particularly, during startup after an emergency shut-off sequence. Track 5 can also include precisors to ensure that tray 11 is held in place during inspection by V3 inspection system 29. Additional precisors can be used if, e.g., a tape and reel module 32 is included in semiconductor inspection system 10. Transporter 5 transports tray 11 from V3 inspection station 29 to output stacker 14 along second inspection path 60. Transporter 5 can be constructed in a similar manner as transporter 1.

g. V3 Inspection Station

V3 inspection station 29 is a single, integrated stations that performs both mark vision inspection and sorting of defective devices received from flipping mechanism 23. For example, V3 inspection station 29 can inspect for incorrect marks, missing marks, incomplete marks, extra ink, broken characters, and orientation check. V3 inspection station 29 also sorts defective or bad devices by placing these devices in reject trays 26A and 26B and non-defective or good devices in a good tray 27. V3 inspection station 29 can also replace defective devices with non-defective devices from good tray 27.

V3 inspection station 29 can include subassemblies, examples of which include a sorting platform, pickup head, and vision system (FIG. 5). The sorting platform can operate with a standard actuator motor driven assembly to provide planar x-axis and y-axis movement. The pickup head can provide vertical z-axis movement using a lead screw driven actuator with a brake. V3 inspection station includes trays 26A and 26B locating on the sorting platform for housing rejected trays. Any number of reject trays can be used in inspection system 10. A tray 27 with known good devices can be used to substitute good devices for rejected devices. V3 inspection station 29 can comprise two pickup heads that perform dedicated pick and place action (of good units and reject units). V3 inspection station 29 can use precisor cavities on the sorting platform that ensure devices can be placed properly in a tray. V3 inspection system 29 can be a computing system coupled to optical components to perform the three-dimensional parameter vision inspection.

h. PC Cabinet

PC cabinet 24 houses computer systems for semiconductor inspection system 10. In one embodiment, cabinet 24 houses five computing systems integrated within semiconductor inspection system 10. One of the computing systems can control sequencing functions, motion control, and data logging (“handler computer”). Such a handler computer can operate a Microsoft Windows® NT 4 operating system. The handler computer can also operate other types of software, e.g., the iCONext software, which interfaces with Windows®. Other computing systems can be used to control the vision inspection stations. Additionally, one or more computers housed in PC cabinet 24 or internal to inspection system can implement operations, methods, steps, and processes, as described herein, during inspection of devices. Furthermore, such computers can be located external to PC cabinet 24 or to semiconductor inspection system 10.

C. Flipping Mechanism Details and Operation

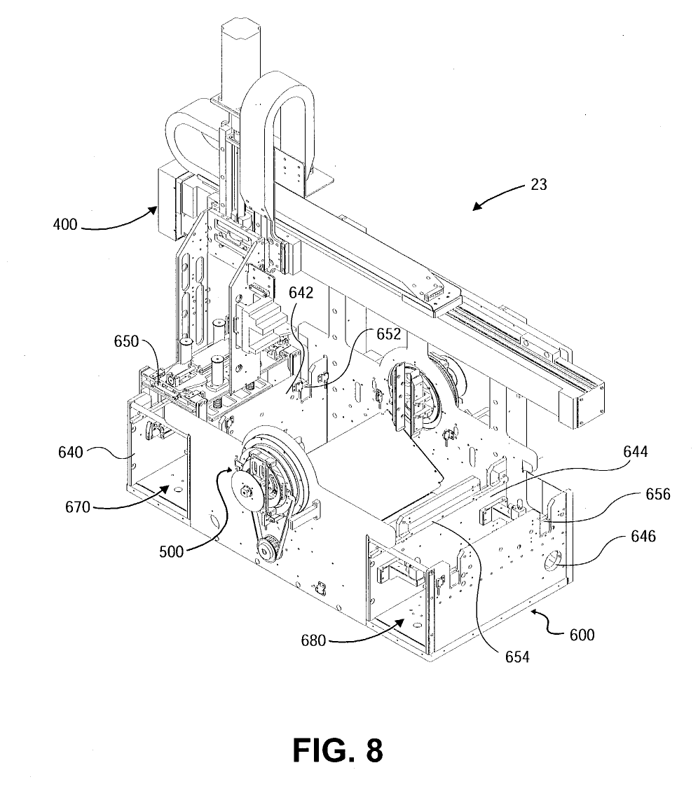

FIGS. 6 through 18 illustrate embodiments of flipping mechanism 23 and its operation. The following describes the components of flipping mechanism 23 and the flipping operation in detail. Referring to FIG. 8, flipper mechanism 23 includes a support frame 600, a tray transfer unit 400, and a flipping unit 500 (“flipper 500”). Tray transfer unit 20 and flipper 22 (shown in FIGS. 2-4) can be represented by tray transfer unit 400 and flipper 500. Support frame 600 is made, for example, of stainless steel and is aligned and secured to the remainder of inspection system 10. Tray transfer unit 400 and flipper 500 are independently mounted on frame 600. This independent mounting enables both tray transfer unit 400 and flipper 500 to be securely mounted and attached to support frame 600, to ensure accurate and reliable operation of flipping mechanism 23, and to reduce stress on components of flipping mechanism 23.

1. Support Frame

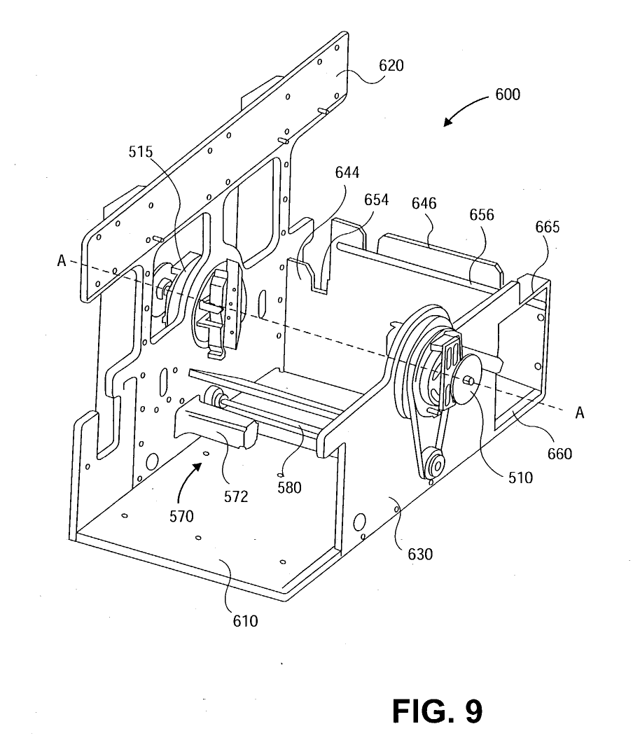

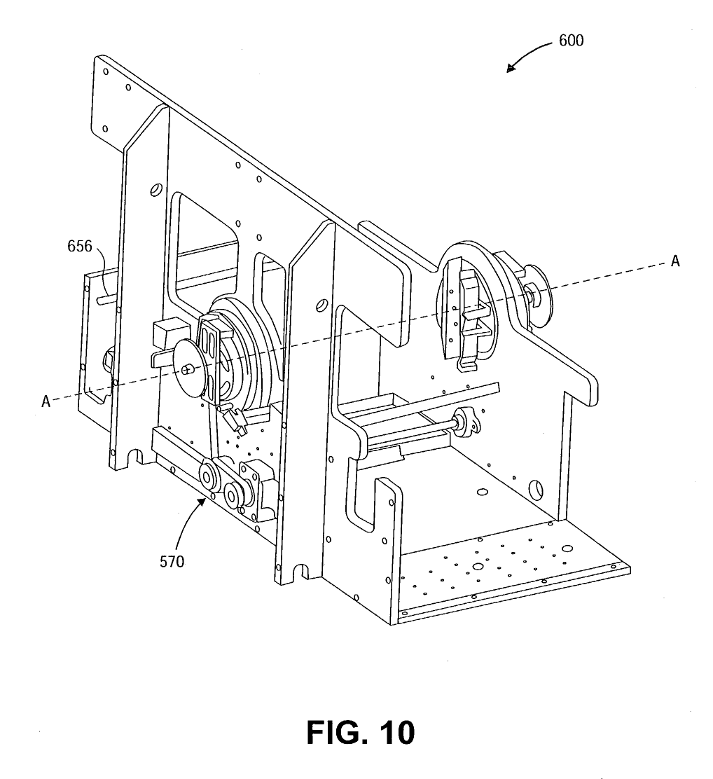

Referring to FIGS. 9-10, frame 600 includes a generally horizontal floor 610, a generally vertical back wall 620 perpendicular to floor 610, and a generally vertical front wall 630. Extending perpendicularly from back wall 620 and floor 610 are four vertical side walls 640, 642, 644 and 646 (side walls 640 and 642 are shown in FIG. 8). Inner side walls 642 and 644 extend from back wall 620 to front wall 630, while outer side walls 640 and 646 extend to the plane of front wall 630 and are supported near the front edge by rods 660 and 665 coupled to front wall 630.

The two side walls 640 and 642, and back wall 620 define loading bay 670 for trays received from transporter 2 along inspection path 50. Loading bay 41 (shown in FIG. 2) can be represented by loading bay 670. The opposing internal surfaces of the side walls 640 and 642 each include a rail or step 650 and 652 on which trays can slide in the y-axis direction into loading bay 670. The two side walls 640 and 642 are spaced apart by a distance slightly greater than the width of a device tray or cover tray. The distance between back wall 620 and front wall 630 is greater than the length of a standard tray so that the tray can be accommodated completely in loading bay 670.

The two side walls 644 and 646, and back wall 620 define unloading bay 680 for placing trays on second inspection path 60. Unloading bay 42 (shown in FIG. 2), can be represented by unloading bay 680. The opposing internal surfaces of the two side walls 644 and 646 can each include a rail or step 654, 656 on which the trays can slide in the y-axis direction out of unloading bay 680. The two side walls 644 and 646 are spaced apart by a distance slightly greater than the width of a standard tray. Since the distance between back wall 620 and front wall 630 is greater than the length of a standard tray, the tray can be accommodated completely in loading bay 670 and unloading bay 680.

2. Flipper

Referring to FIGS. 9 and 11-13, flipper 500 can include a pair of oppositely facing clamping devices including a first clamping device 510 and second clamping device 515, and a drive unit 570 comprising a motor 572 and a tandem axle 580. First clamping device 510 is rotatably mounted in a circular aperture formed in front wall 630 of frame 600. Second clamping device 515 is rotatably mounted in a circular aperture formed in back wall 620 of frame 600. The apertures in front and back walls 630 and 620 are aligned to allow clamping devices 510 and 515 to rotate in the plane of the front and back walls about a common axis A-A. First and second clamping devices 510 and 515 operate in the same way but are constructed as mirror images of each other in a plane perpendicular to the axis A-A.

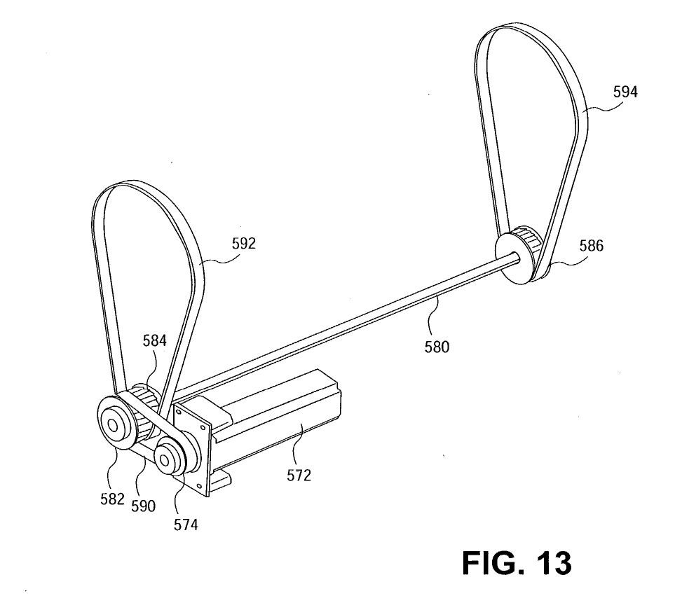

Drive unit 570 is coupled to first and second clamping devices 510 and 515 to simultaneously rotate the clamping devices about the axis of rotation A-A. Referring back to FIG. 9, drive unit 570 has motor 572 mounted on back wall 620 of frame 600 and tandem axle 580 rotatably mounted towards one end in an aperture of front wall 630, and towards the other end in an aperture of back wall 620. The relative position of the two apertures enables the tandem axle to rotate about an axis parallel with the A-A axis of clamping devices 510 and 515. Drive unit 570 further includes a first drive belt 590 coupled to a cog 574 on motor 572, and to a cog 582 on tandem axle 580 to transfer rotational power from motor 572 motor to tandem axle 580 (shown in FIG. 13). Two further drive belts 592 and 594 of drive unit 570 simultaneously transfer rotational power via a pair of cogs 584 and 586 from tandem axle 580 to clamping devices 510 and 515.

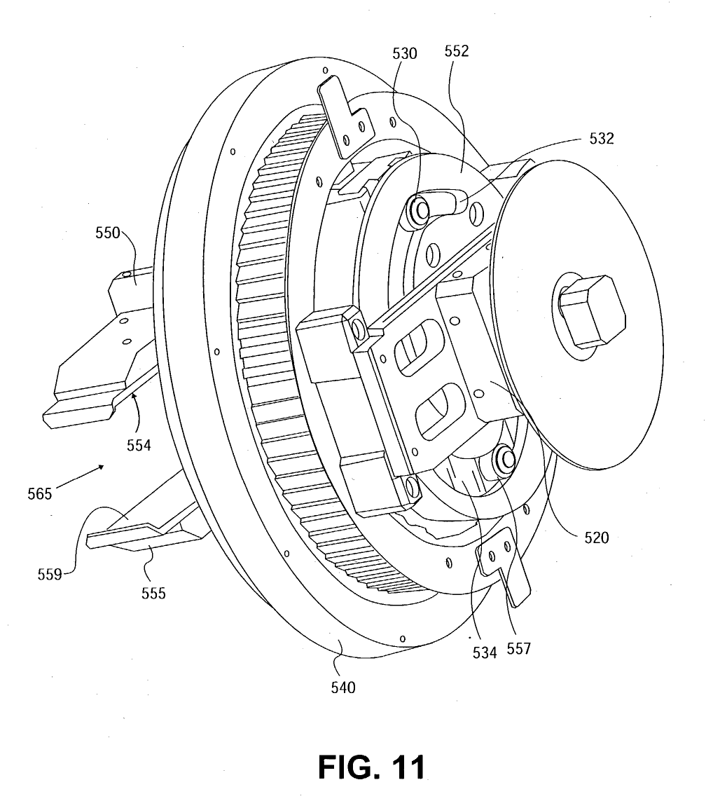

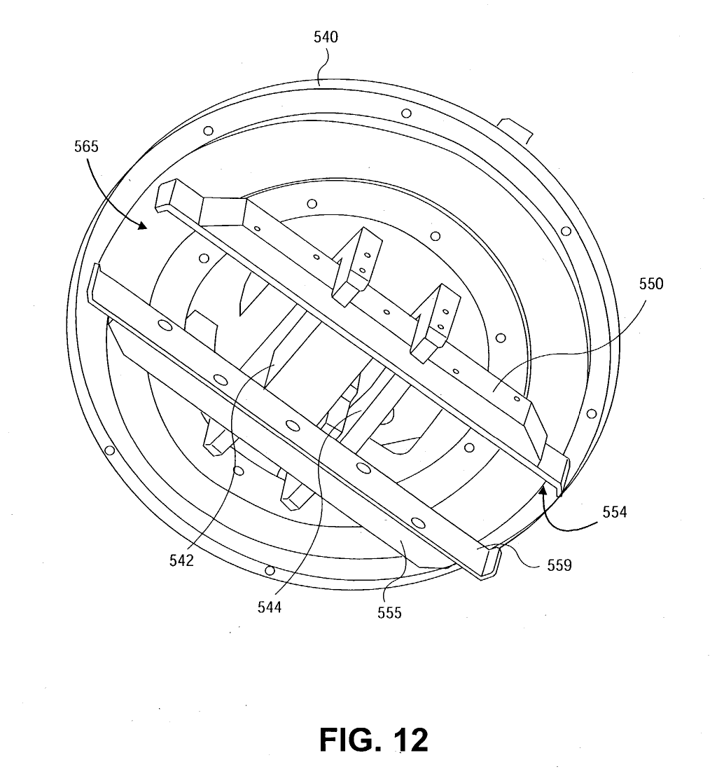

Each clamping device 510 and 515 is designed to clamp the end of a tray or a pair of trays (shown in FIG. 11). Each clamping device comprises a clamp body 540, a pair of jaw units 550, 555, a cam plate 530, and a pneumatic rotary cylinder 520. The pair of jaw units 550 and 555 comprise jaw surfaces 554 and 559, which are spaced apart to form a jaw slot 565. Clamp body 540 comprises a pair of elongated guide apertures 532 and 534, which linearly guide each jaw unit 550 and 555 radially towards or away from the rotational axis A-A of the clamping device (shown in FIG. 12). The pair of jaw units 550 and 555 are driven radially towards or away from the rotational axis A-A by a cam plate 530, which acts on a cam follower 552 and 557 attached to each of the jaw units 550 and 555.

Cam plate 530 comprises a pair of spiral cam slots 532 and 534 such that rotation of cam plate 530 in one direction forces each of the cam followers 552 and 557 along a radial path of decreasing radius relative to clamping body 540. Rotation of cam plate 530 in an opposite direction forces each of the cam followers 552 and 557 along a radial path of increasing radius relative to clamping body 540. Therefore, by rotating cam plate 530 in one direction, jaw units 550 and 555 and jaw surfaces 554, 559 are brought towards each other thus closing jaw slot 565. Conversely, by rotating cam plate 530 in the other direction, jaw units 550 and 555 and the jaw surfaces 554 and 559 are moved away from each other thus opening jaw slot 565.

3. Tray Transfer Unit

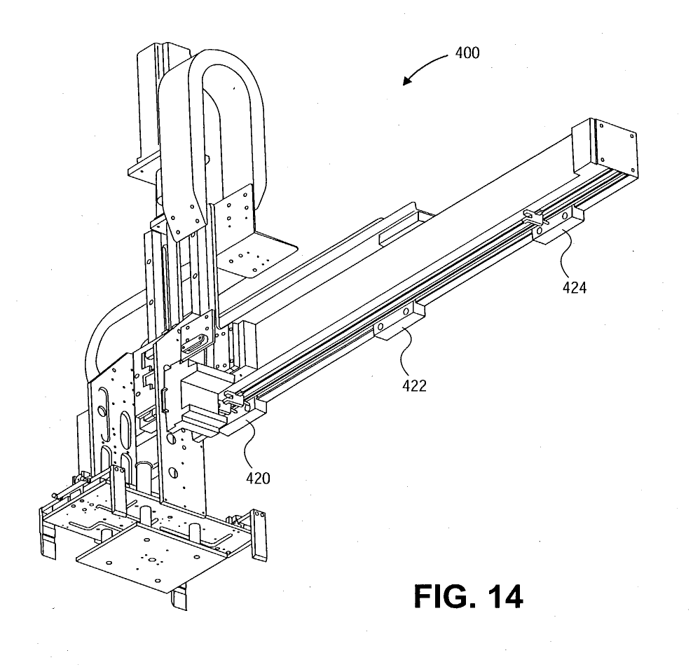

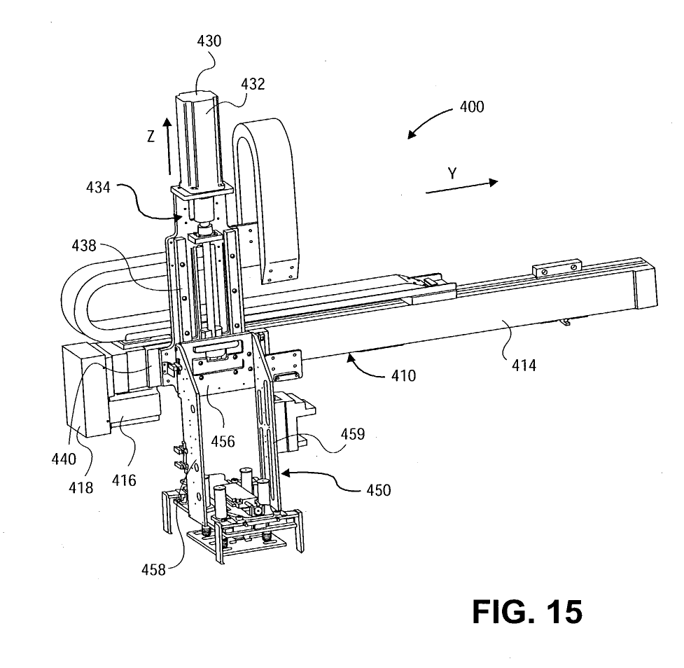

Tray transfer unit 400 is shown in more detail in FIGS. 14 and 15. Tray transfer unit 400 comprises an y-axis actuator 410, a z-axis actuator 430, and a tray handler 450. Tray handler 450 is configured to grab and release trays in accordance with the operation sequence of flipping mechanism 23, as is described in more detail below. Independent operation of y-axis actuator 410 and z-axis actuator 430 enables tray transfer unit 400 to move device or cover trays between x-y plane. Orthogonal actuators of this kind are well known in the art and available as in pick and place machinery, and have been developed in these field to be highly reliable, accurate and commercially available.

Tray handler 450 comprises a carriage 456 which is slidably coupled to a z-linear guide 438 of the z-axis actuator 430. The coupling enables carriage 456 and thus tray handler 450 to slide in a z-axis direction up and down the z-linear guide 438. The z-axis actuator 430 further comprises a ball screw shaft 434 which is aligned with the z-axis, and is coupled to a ball bearing follower contained in carriage 456. A servo-motor 432 of the z-axis actuator 430 drives ball screw shaft 434 in a clockwise or anti-clockwise rotational direction about the z-axis. Rotation of screw shaft 434 forces the ball bearing follower along the threads of screw shaft 434 which in turn drives the carriage up and down the z-linear guide 438.

The y-axis actuator 410 is constructed in a similar way to z-axis actuator 430 except that in general each component is aligned to the x-axis instead of the z-axis. The y-axis actuator 410 comprises a carriage 440, which is slidably coupled to a y-linear guide of a x-axis actuator (not shown). Whereas z-linear guide 438 of z-axis actuator 430 is aligned with the z-axis, the y-linear guide of y-axis actuator 410 is aligned with y-axis and is contained in a housing 414 of y-axis actuator 410. The coupling between carriage 440 and the y-linear guide enables the carriage 440 and thus z-axis actuator 430 and tray handler 450 to slide in an y-axis direction back and forth along the y-linear guide.

The y-axis actuator 410 further comprises a y-ball screw shaft (not shown) which is also contained in housing 414 and is aligned with the y-axis. The y-ball screw shaft of the y-axis actuator is coupled to a ball bearing follower contained in the carriage 440 (not shown). A servo-motor 416 of the y-axis actuator 410 drives the y-ball screw shaft via a belt system 418 in a clockwise or anti-clockwise rotational direction about the y-axis. Rotation of the y-ball screw shaft forces the ball bearing follower of carriage 440 along the threads of screw shaft which in turn drives carriage 440 back and forth along the x-linear guide. The y-axis actuator 410 can also comprise a set of three mounting points 420, 422, 424 for mounting tray transfer unit 400 to back wall 620 of support frame 600, as shown in FIG. 8.

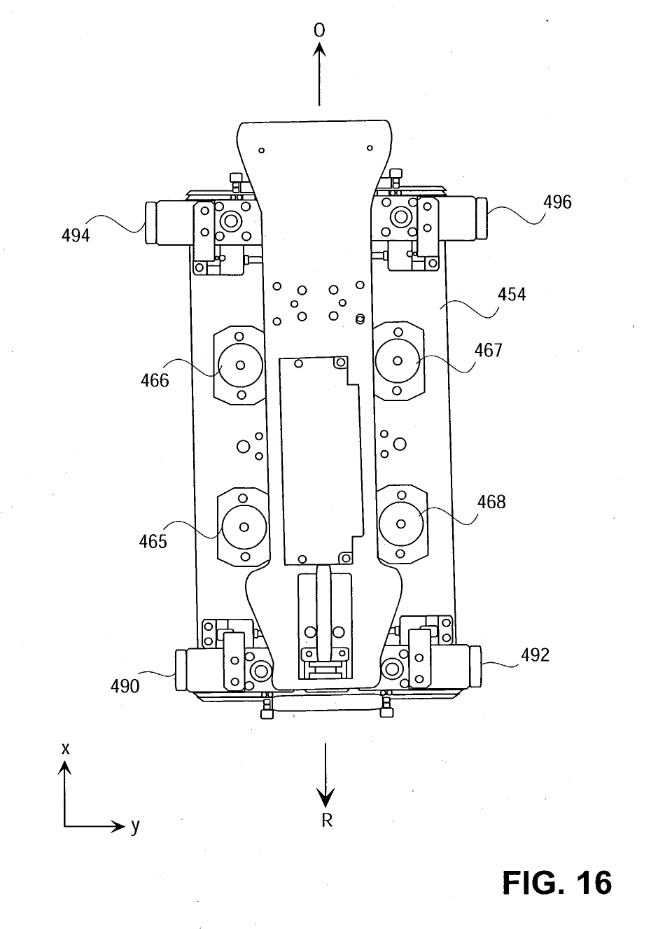

The main functional components of tray handler 450 are supported by a support plate 454. Support plate 454 is mounted on the lower end of two arms 458, 459 which extend down from the tray handler carriage 456. FIGS. 16-18 illustrate the main functional components of tray handler 450 and support plate 454 in more detail. The main functional components of tray handler 450 that make contact with the trays comprise four fingers 490, 492, 494, 496, and a pressure plate 460.

Each of the four fingers (490, 492, 494, 496) comprises a horizontal portion, which is located over the top surface of support plate 454 and extends outwards over the side edge of the top surface to join with a vertical portion of each finger. The vertical portion of each finger is joined at one end to the horizontal portion of the finger and extends generally downwards away from the support plate 454 to an end containing a hook. The four hooks 491, 493, 495, 497 of the four fingers 490, 492, 494, 496 face inwards towards tray handler 450 and are designed to latch onto edge rails on the device or cover trays.

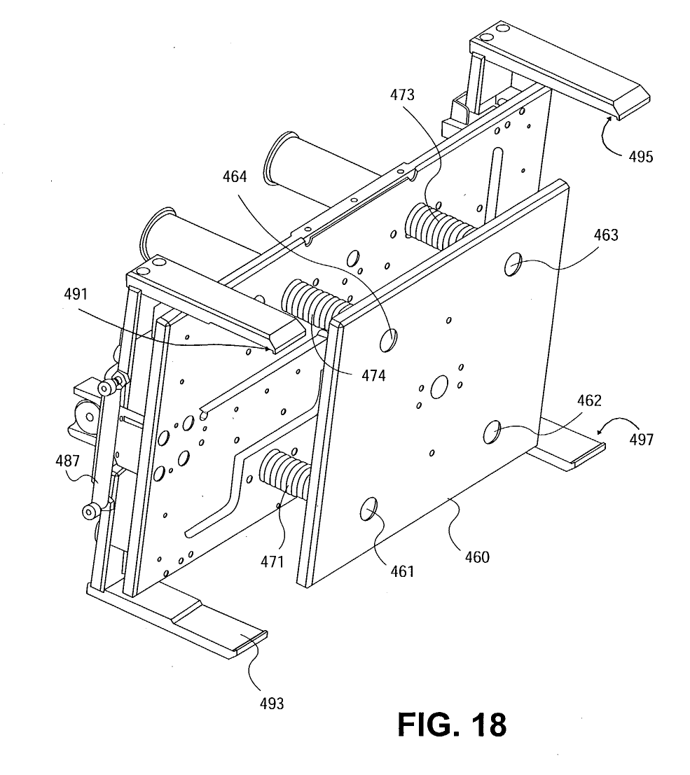

The two fingers 490 and 492 are illustrated in an operational position. In this operational position, the opposing pair of fingers 490, 492 are spaced apart such that the vertical portions of the fingers are separated by a distance slightly greater than the device or cover tray width. However, the hooks of each finger extend inwards from the vertical portion and are spaced apart by a distance slightly less than the device or cover tray width. Accordingly, a top surface on each hook can overlap with and abut a bottom surface of a side edge of the device or cover tray such that when the tray handler 450 is lifted upwards in the z-axis direction the hook can apply an upwards force on the side edge to lift the tray upwards, as shown in FIG. 18. Once lifted, the tray is prevented from dropping by the continued abutting force of the top surface of the hook.

The horizontal portions of the four fingers 490, 492, 494, 496 are mounted on support plate 454 such that the fingers can slide along the x-axis towards or away from the support plate 454. In the operational position just described, the fingers are positioned close to support plate 454. The fingers are moved out of the operational position by sliding them outwards away from support plate 454 to a release position. Fingers 494 and 496 are illustrated in this release position.

A finger activator 480 is mounted on support plate 454 for moving the fingers 490, 492, 494, 496 between the operational position and the release position. The finger activator 480 comprises first and second springs 487 and 488, which force the first and second pairs of opposing fingers 490, 492 and 494, 496, respectively, towards the operational position. For example, fingers 494 and 496 would be forced towards operational position under the action of spring 488.

Finger activator 480 also comprises an active camming system for urging the first and second pairs of opposing fingers 490, 492 and 494, 496 against the spring force to the release position. The active camming system comprises a cam plate 481 with a camming surface 482, 483, 484, 485 for each finger 490, 492, 494, 496, and a pneumatic plunger 486 for driving cam plate 481 back and forth linearly along the y-axis. Cylindrical cam followers on the four fingers 490, 492, 494, 496 abut the respective cam surfaces of the cam plate under the action of the two springs 487, 488. Cam plate 481 is illustrated in the operational position. When it is desired to move the fingers 490, 492, 494, 496 to the release position, the pneumatic plunger 486 is activated by pneumatic valves to force cam plate 481 in the direction R. When it is desired to return fingers 490, 492, 494, 496 to the operational position, pneumatic plunger 486 is activated by different pneumatic valves to force cam plate 481 in the direction O opposite to the direction R.

Pressure plate 460 is supported in a generally horizontal position below and parallel with support plate 454 by four independent shafts 461, 462, 463, 464. Each shaft 461, 462, 463, 464 is contained in a respective bushing 465, 466, 467, 468 on the support plate, allowing the plate to move in a vertical z-axis direction towards the support plate 454, or up to a limited distance away from the support plate 454. Four compression springs 471, 472, 473, 474 surround the four shafts 461, 462, 463, 464 in between the pressure plate and the support plate. The springs act on the lower surface of the support plate and the upper surface of the support plate to force the pressure plate in a downwards z-axis direction. Alternatively, two springs can be used on diagonally opposite shafts 461, 463 or 462, 464.

Pressure plate 460 is designed to apply downward pressure evenly onto the top surface of a tray or a pair of stacked trays. This downward pressure helps in the alignment of a cover tray when it is positioned on top of a device tray. The downward pressure also helps with regulating the force between the four hooks 491, 493, 495, 497 of the four fingers 490, 492, 494, 496 and the edges of trays being lifted by the tray transfer unit 400. The downward pressure further helps with the clamping of stacked trays against vibrators during up and down movement of vibrators (not shown). Although not shown, vibrators can comprise two cylinders pneumatically driven to vibrate the trays being clamped by the above fingers and hooks from the underside.

4. Flipping Operation

The operating sequence of flipper mechanism 23 of FIGS. 3-4 and 8-15 will now be described with reference to the flow diagram in FIG. 6 of the flipping operation 600, and with further reference to FIGS. 7A-7L that illustrate the basic movement sequences of the device tray (D) and the cover tray (C) as they are processed by flipper mechanism 23. The cover tray (C) is generally identical to the device tray (D), and can conform to the JEDEC tray standard. The trays (D,C) comprise a first side (D1, C2) and an opposite second side (D2, C2).

Referring to FIG. 6, initially, a check made to determine whether there is a cover tray (C1) in the ready position (step 602). As shown in FIG. 7A, the cover tray (C) can be in a ready position by the tray handler 450 (shown in FIG. 15) placing or holding it above loading bay 670 (FIG. 8). The cover tray (C) can have the same orientation as a device tray in input stacker 12. In this example, the correct orientation for the cover tray (C) is having the first side (C1) facing upwards to match that of the incoming device tray (D). The trays are initially both orientated with the first side (D1, C1) facing upwards, and the second side facing downwards. The device tray (D) contains devices, which have been loaded in an array of pockets on the first side D1 of the device tray (D). The cover tray (C) contains no devices and is located in the ready position. If the cover tray (C) is not in the ready position, an empty tray is delivered to the ready position (step 603). This can be done manually by a human operator, or by automatically delivering an initial empty tray along first inspection path 50 and lifted to the ready position.

After the cover tray (C) is in the ready position, the device tray (D) containing devices under inspection is received in the loading bay 670 (step 604). The device tray (D) is transported from input stacker 12 to a first location, in this particular embodiment, loading bay 670, in a first direction. This direction can be in the positive (+) x-axis direction. The devices in the device tray (D) can also be inspected by V1 and V2 inspection stations 16 and 18 (FIGS. 24), respectively, prior to being received at loading bay 670. At loading bay 670, the device tray (D) containing devices under inspection will be positioned directly beneath the cover tray (C), as shown in FIG. 7B. The devices under inspection can be, e.g., BGA packages with ball connections facing upwards in the dead-bug orientation.

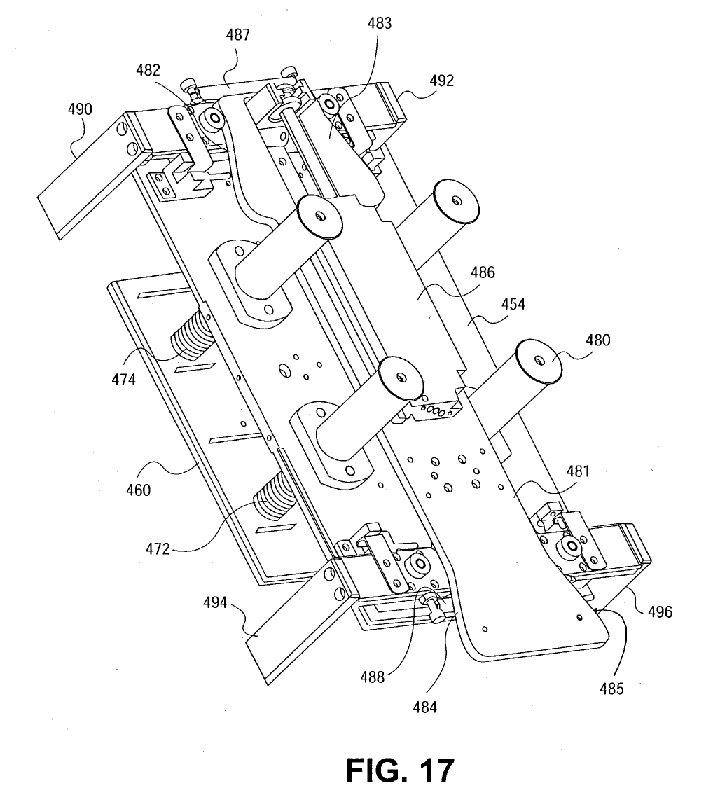

The cover tray (C) is then aligned over and with the device tray (D) (step 606). In this step, the cover tray (C) is initially lowered onto the device tray (D) in a negative (−) z-axis direction by tray handler 450 (shown in FIG. 15) using a z-axis actuator 430. Throughout this movement, the fingers of tray handler 450 remain in the operational position to hold the cover tray (C). Tray handler 450 moves down sufficiently for the bottom surface of the cover tray to abut the top surface of the device tray (D), as shown in FIG. 7C. Tray handler 450 then continues to move down slightly to release the top surface of the hooks from the side edge of the cover tray (C) such that the downward force of pressure plate 460 (FIG. 17) urges the cover tray (C) into alignment with the device tray (D).

The fingers of tray handler 450 then move to the release position, and tray handler 450 is raised to a height where the pressure plate is no longer applying pressure on the cover tray (C). The empty tray handler 450 is then lowered again to reapply pressure on the cover tray (C) and to lower tray handler 450 to a position where the hooks can latch under the edges of the device tray (D). This sequence of applying pressure, releasing or reducing the pressure, and then reapplying the pressure helps with the alignment of the cover tray (C) with the device tray (D) (“self-alignment process”). However, alignment is still possible even without upward movement of the tray handler 450. That is, tray handler 450 could continue moving downwards and still achieve alignment of the cover tray (C) and the device tray (D). Because the trays are aligned in the loading bay 670, side walls 640 and 642 (FIG. 8) of loading bay 670 help to self-align the trays together. Two through-beam sensors can detect whether the cover (C) tray is sitting too high in the loading bay 670. Sensors can be also used to indicate that the cover tray (C) has been misaligned with the device tray (D).

Next, as shown in FIGS. 7D and 7E, the cover and device trays (C, D), also referred to as stacked trays, are transferred to flipper 500 (FIG. 8) at a flipping location (step 608). The stacked trays can be lifted vertically in the positive (+) z-axis direction and then moved laterally in the positive (+) y-axis direction to the flipping location. In one embodiment, the flipping location is above and lateral to first inspection path 50. Furthermore, in this manner, devices in a tray can move from multiple x-y planes. In this step, prior to the lateral horizontal movement in the positive (+) y-axis direction, the stacked trays can be raised to clear the side walls of loading bay 670. This raising movement begins with the fingers of tray handler 450 being moved to the operational position under the action of the cam plate. Tray handler 450 then lifts the stacked trays by action of the z-axis actuator 430 and in doing so latches the hooks under the edges of the device tray and begins to the lift the pair of stacked trays. The trays are lifted until the device tray has cleared side wall 642 of loading bay 670.

In the raised position, the trays are moved horizontally (positive (+) y-axis direction) by the action of the y-axis actuator 410 (FIG. 15) towards flipper 500. Flipper 500 has both jaw slots 565 (FIG. 12) in the open position and horizontally aligned, ready to receive the trays. Tray handler 450 continues to move the trays horizontally into the gap between the jaw surfaces of the two clamping devices 510 and 515 (FIG. 9). The final action in the transfer of the trays to the flipping unit involves closing the jaws of the clamping devices 510 and 515 using the rotating cam plate under the control of the pneumatic motor which controls the pressure of the jaws on the trays. The horizontal path of the trays is slightly below the axis A-A of the clamping devices so that as the jaws close, the trays are raised slightly to release the edges of the device tray from the hooks. The fingers of tray handler 450 are released and tray handler 450 is raised to a vertical position which allows the trays to rotate.

Subsequently, the trays are flipped by flipper 500 to invert or flip the devices held between the two trays (C, D) (step 610). The clamping devices 510 and 515, their respective jaws, and the trays are rotated 180 degrees by drive unit 570 (FIG. 8). Because the trays are rotated about their longest axis, the torque experience by drive unit 570 is small in which case the stress on flipper 500 is thereby reduced. As shown in FIG. 7F, the trays after flipping result with the second surface (D2) of the device tray now facing upwards.

After flipping, flipping mechanism 23 using tray handler 450 moves the trays from the flipping location to a location above unloading bay 680 (FIG. 8) (step 612). Tray handler 450 moves down to the position just before the jaws were closed. The jaws are then opened and the trays are held between the pressure plate and the hooks. The y-axis actuator 410 then moves tray handler 450 and the trays horizontally (in the same y-axis direction as it arrived at flipper 500 towards unloading bay 680. Once the trays are located directly above the unloading bay 680, shown in FIG. 7G, the z-axis actuator 430 moves the trays down until the cover tray supporting the flipped devices abuts the rails 654 and 656 (FIG. 8) in unloading bay 680, as shown in FIG. 7H. Tray handler 450 continues to move down slightly to release the hooks from the edges of the cover tray.

The finger are then released and a pneumatic vibration unit comprising two vertically aligned cylinders jolts the trays upwards at least once against the force of the pressure plate 460. The purpose of this vibrating action is to shake loose any devices that are stuck in the device tray and have not properly fallen onto the cover tray. This vibration step is optional can be selectively initiated by a user, or automatically controlled.

Next, the trays are separated in which the device tray (D) moves upwards from the cover tray (C) (step 614). As shown in FIG. 71, this is achieved by moving tray handler 450 upwards slightly, closing the fingers so that the hooks located just under the edge of the device tray, and then raising tray handler 450 further using the z-axis actuator 430. According to the steps 616, 618, and 620, the device tray is lifted vertically out of unloading bay 680, as shown in FIGS. 71-7, moved horizontally to the flipper 500 (FIG. 7J), transferred to the jaws of the flipper 500 and flipped (FIG. 7K) to its original orientation with surface D1 facing upwards, and then moved horizontally to the ready position where it can act as the next cover tray (FIG. 7L).

Meanwhile, transporter 4 (FIGS. 4-5) transports the cover tray with the flipped devices from unloading bay 680 to V3 inspection station 29 along second inspection path 60. For example, as shown in FIG. 7K, the cover tray (C) can move in the negative (−) x-axis direction. Further operations and steps can be performed by flipping mechanism 23 in which the cover tray (C) from unloading bay 680 is returned to the loading bay 670 by tray transfer unit 450. In such a process, the cover tray (C) can be flipped again by flipper 500 before being transferred to loading bay 670 using the same process described above. Specifically, the four fingers and hooks of flipping unit 500 grab only the cover tray for flipping and returned to loading bay 670 to wait for a subsequent device tray.

Thus, a semiconductor inspection system and method have been described. Furthermore, while there has been illustrated and described what are at present considered to be exemplary implementations and methods of the present invention, various changes and modifications can be made, and equivalents can be substituted for elements thereof, without departing from the true scope of the invention. In particular, modifications can be made to adapt a particular element, technique, or implementation to the teachings of the present invention without departing from the spirit of the invention.

What is claimed is:

1. An inspection system, comprising:
an input stacker;
an output stacker;
a flipping mechanism to move devices from a first inspection path to a flipping location, to flip the devices at the flipping location, and to move the devices from the flipping location to a second inspection path;
a first transport to transport the devices from the input stacker to the flipping mechanism along the first inspection path in a first direction;
a second transport to transport the devices from the flipping mechanism to the output stacker along the second inspection path in a second direction, the second direction being different than the first direction; and
a plurality of inspection stations to inspect the devices being transported along the first inspection path and the second inspection path.

2. The inspection system of claim 1, wherein the devices are transported in multiple x-axis, y-axis, and z-axis directions from the input stacker to the output stacker.

3. The inspection system of claim 2, wherein the devices are transported from the input stacker to the output stacker along a non-linear path.

4. The inspection system of claim 1, wherein the input stacker and the output stacker are located in close proximity to each other.

5. The inspection system of claim 1, wherein the inspection stations include a first inspection station and second inspection station arranged serially along the first inspection path to perform two-dimensional and three-dimensional parameter inspection on the devices, respectively.

6. The inspection system of claim 5, wherein the inspection stations include a third inspection station arranged along the second inspection station path that performs both mark inspection and sorting of defective devices.

7. The inspection system of claim 1, wherein the flipping location is lateral to and above the first inspection path.

8. The inspection system of claim 1, wherein the flipping mechanism flips devices contained in a first tray into a second tray.

9. The inspection system of claim 8, wherein the flipping mechanism self-aligns the second tray with the first tray.

10. The inspection system of claim 8, wherein the flipping mechanism includes one or more sensors to provide information regarding at least one of the first tray and second tray.

11. The inspection system of claim 8, wherein the first tray is transported directly to the second inspection path without flipping the devices.

12. The inspection system of claim 8, wherein the flipping mechanism comprises:
first fingers to grab a first end of the first and second trays; and
second fingers to grab a second end of the first and second trays, wherein the first fingers and second fingers are used to rotate the first and second trays synchronously.

13. The inspection system of claim 12, wherein the flipping mechanism further comprises:
a tandem shaft attached with the first and second fingers to rotate the first and second trays.

14. The inspection system of claim 9, wherein the flipping mechanism further comprises:
vibrating means to vibrate at least one of the first tray and second tray.

15. An inspection method for inspecting devices, the method comprising:
transporting devices in a first tray from an input stacker to at least one inspection station along a first inspection path;
inspecting the devices in the first tray at each inspection station along the first inspection path;
transporting the devices in the first tray to a flipping mechanism along the first inspection path;
flipping the devices into a second tray at a flipping location and transporting the devices in the second tray to a second inspection path;
transporting the devices in the second tray to an integrated inspection and sorting station from the flipping mechanism along the second inspection path; and
performing mark inspection of the devices in the second tray and sorting defective devices in the second tray at the single, integrated inspection and sorting station.

16. The method of claim 15, wherein the devices in the first tray are transported along the first inspection path in a first direction and the devices in the second tray are transported along the second inspection path in a second direction, the second direction being different than the first direction.

17. The method of claim 15, wherein the step of inspecting the devices in the first tray further comprises:
inspecting two-dimensional parameters on the devices in the first tray at a first inspection station; and
inspecting three-dimensional parameters on the devices in the first tray at a second inspection station.

18. The method of claim 15, wherein the step of flipping the devices further comprises:
self-aligning the second tray on the first tray in a loading bay of the flipping mechanism;
moving the first and second trays vertically and laterally to the flipping location from the loading bay; and
moving the first and second trays laterally and vertically from the flipping location into an unloading bay of the flipping mechanism.

19. The method of claim 18, wherein the step of flipping the devices further comprises:
sensing if the second tray is properly aligned with the first tray.

20. The method of claim 15, wherein the step of flipping the devices further comprises:
rotating synchronously the first and second trays.

21. The method of claim 15, further comprising:
vibrating at least one of the first tray and second tray.

22. The method of claim 21, wherein the step of vibrating at least one of the first tray and second tray further comprises vibrating at least one of the first tray and second tray before or after flipping the devices.

23. The method of claim 15, further comprising:
transporting the devices in the second tray unit from the integrated inspection and sorting station to at least one of a tape and reel module and a gang pick-and-place module along the second inspection path.

24. The method of claim 15, wherein the devices are transported to and through the inspection stations and flipping mechanism along a non-linear path.

25. A flipping mechanism comprising:
a loading bay and an unloading bay;
a support frame;
a flipping unit mounted on the support frame, the flipping unit to flip at least one of a first tray and a second tray at a flipping location laterally from the loading bay; and
a tray transfer unit mounted on the support frame, the transfer unit to move at least one of the first tray and second from the loading bay to at least one of the flipping location and unloading bay.

26. The flipping mechanism of claim 25, wherein the tray transfer unit and the flipping unit are mounted independently on the support frame.

27. The flipping mechanism of claim 25, wherein the tray transfer unit places the second tray on the first tray at the loading bay and moves the first and second trays to the flipping location, and wherein the flipping unit flips devices in the first tray into the second tray.

28. The flipping mechanism of claim 27, wherein the tray transfer unit moves at least one of the first tray and second tray in vertical and lateral directions.

29. The flipping mechanism of claim 27, wherein the flipping unit comprises:
first fingers to grab a first end of at least one of the first tray and the second tray;
second fingers to grab a second end of at least one of the first tray and the second tray; and
a rotating unit to rotate the at least one of the first tray and the second tray using the first and second finger units.

30. The flipping mechanism of claim 29, wherein the rotating unit rotates at least one of the first tray and the second tray synchronously at each first end and second.

31. The flipping mechanism of claim 25, wherein at least one of the loading bay and unloading bay comprises a vibrating unit to vibrate at least one of the first tray and the second tray.

32. The flipping mechanism of claim 31, wherein the tray transfer unit is to move the devices in the first tray directly to the unloading bay.

33. An inspection method for inspecting devices comprising:
transporting devices in a first tray from an input stacker to at least one inspection station along a first inspection path;
inspecting the devices in the first tray at the inspection station;
transporting the devices in the first tray to a flipping mechanism along the first inspection path;
moving the devices in the first tray to a second tray using the flipping mechanism;
transporting the devices in the second tray to an integrated inspection and sorting station from the flipping mechanism along a second inspection path; and
performing mark inspection of the devices in the second tray and sorting defective devices in the second tray at the integrated inspection and sorting station.

34. The inspection method of claim 33, further comprising:
transporting the devices in the first tray to an output stacker such that devices are transported form the input stacker to the output stacker along a non-linear path.
